(19) United States
(12) Patent Application Publication
(10) Pub. No.: US 2016/0021673 A1
(43) Pub. Date: Jan. 21, 2016

(54) IMS BASED WWAN-WLAN MOBILITY

(71) Applicant: QUALCOMM Incorporated, San Diego, CA (US)

(72) Inventors: Seyed Ali Ahmadzadeh, Santa Clara, CA (US); Srinivasan Balasubramanian, San Diego, CA (US); Gary Chia-Jui Chang, San Diego, CA (US); Chinmay Dhodapkar, San Diego, CA (US)

(21) Appl. No.: 14/801,058

(22) Filed: Jul. 16, 2015

Related U.S. Application Data
(60) Provisional application No. 62/026,528, filed on Jul. 18, 2014.

(51) Int. Cl. H04W 72/08; H04N 21/63; H04W 24/08; H04W 36/30; H04W 28/18; H04L 29/06

(52) U.S. Cl. CPC H04W 72/085; H04W 28/18; H04L 65/608; H04W 24/08; H04L 65/80; H04W 36/30; H04N 21/63; H04W 84/02

(57) ABSTRACT

Methods, systems, and devices for IMS based WWAN-WLAN mobility are described. A user equipment (UE) may generate channel quality metrics and media performance metrics for a source radio access technology (RAT). The UE may then select a state for the source RAT metrics. The UE may also generate channel quality metrics for a target RAT and select a state for the target RAT. The UE may make a handover decision based on the states of the RATs and on priority levels for the RATs.

### CROSS REFERENCES

The present application for patent claims priority to U.S. Provisional Patent Application No. 62/026,528 by Ahmadzadeh et al., entitled “IMS Based WWAN-WLAN Mobility,” filed Jul. 18, 2014, assigned to the assignee hereof, and expressly incorporated by reference herein.

### BACKGROUND

The following relates generally to wireless communication, and more specifically to internet protocol multimedia subsystem (IMS) based wireless wide area network (WWAN)-wireless local area network (WLAN) mobility. Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code division multiple access (CDMA) systems, time division multiple access (TDMA) systems, frequency division multiple access (FDMA) systems, and orthogonal frequency division multiple access (OFDMA) systems, e.g., a Long Term Evolution (LTE) system.

Generally, a WWAN multiple-access communications system may include a number of base stations, each simultaneously supporting communication for multiple mobile devices or other user equipment (UE) devices. Base stations may communicate with UEs on downstream and upstream links. Each base station has a coverage range, which may be referred to as the coverage area of the cell. A WLAN network may include a number of network devices, e.g., access points (AP), that can support communication for a number of wireless devices. A UE may establish a connection with an AP or base station for both downlink (DL) and uplink (UL) communications.

In some cases, a UE may utilize multimedia services through a WWAN or a WLAN. For example, a UE may download or upload video content. An IMS may be a means for facilitating multimedia services using an internet protocol (IP) system. In some cases, a UE may be within the coverage area of both a WWAN and a WLAN.

### SUMMARY

The described features generally relate to a set of improved systems, methods, and apparatuses for internet protocol multimedia subsystem—(IMS) based wireless wide area network (WWAN)-wireless local area network (WLAN) mobility. A user equipment (UE) may generate channel quality metrics and media performance metrics for a source radio access technology (RAT). The UE may then select a state (e.g., good or bad) for the source RAT metrics. The UE may also generate channel quality metrics for a target RAT and select a state for the target RAT. The UE may make a handover decision based on the state of the source RAT and the state of the target RAT. The UE may also base the handover decision on priority levels for the source and target RATs. For example, the UE may select (e.g., remain with or handover to) the RAT with the higher state if the priority levels are equal. If one RAT has a higher priority, the UE may select the high priority RAT unless, in some case, the state of the high priority RAT is worse than the state of the low priority RAT.

A method of IMS based WWAN-WLAN mobility is described. The method may include determining a set of source channel quality metrics for a source RAT, determining a set of media performance metrics for the source RAT, selecting a first state for the source RAT based on the set of source channel quality metrics and the set of media performance metrics for the source RAT, determining a set of target channel quality metrics for a target RAT, selecting a second state for the target RAT based on the set of target channel quality metrics for the target RAT, and making a mobility determination based at least in part on the first state and the second state.

An apparatus for IMS based WWAN-WLAN mobility is described. The apparatus may include means for determining a set of source channel quality metrics for a source RAT, means for determining a set of media performance metrics for the source RAT, means for selecting a first state for the source RAT based on the set of source channel quality metrics and the set of media performance metrics for the source RAT, means for determining a set of target channel quality metrics for a target RAT, means for selecting a second state for the target RAT based on the set of target channel quality metrics for the target RAT, and means for making a mobility determination based at least in part on the first state and the second state.

A further apparatus for IMS based WWAN-WLAN mobility is described. The apparatus may include a processor, memory in electronic communication with the processor, and instructions stored in the memory. The instructions may be executable by the processor to determine a set of source channel quality metrics for a source RAT, determine a set of media performance metrics for the source RAT, select a first state for the source RAT based on the set of source channel quality metrics and the set of media performance metrics for the source RAT, determine a set of target channel quality metrics for a target RAT, select a second state for the target RAT based on the set of target channel quality metrics for the target RAT, and make a mobility determination based at least in part on the first state and the second state.

A non-transitory computer-readable medium storing code for IMS based WWAN-WLAN mobility is also described. The code may include instructions executable by a processor to determine a set of source channel quality metrics for a source RAT, determine a set of media performance metrics for the source RAT, select a first state for the source RAT based on the set of source channel quality metrics and the set of media performance metrics for the source RAT, determine a set of target channel quality metrics for a target RAT, select a second state for the target RAT based on the set of target channel quality metrics for the target RAT, and make a mobility determination based at least in part on the first state and the second state.

Some examples of the method, apparatuses, and/or non-transitory computer-readable medium described above may further include features of, means for, and/or processor-executable instructions for identifying a first priority level for the source RAT and a second priority level for the target RAT. In some examples, determining the set of target channel quality metrics includes deciding to measure a channel quality of the target RAT based on the first priority level.

In some examples of the method, apparatuses, and/or non-transitory computer-readable medium described above, making the mobility determination is based on the identified first and the second priority levels or on policy based information. Some examples may include performing a handover from the source RAT to the target RAT based on making the mobility determination.

Some examples of the method, apparatuses, and/or non-transitory computer-readable medium described above may further include features of, means for, and/or processor-executable instructions for receiving a real-time transport protocol control protocol (RTCP) report, extracting a media performance metric for a far end channel from the RTCP report, and the set of media performance metrics is based at least in part on the extracted media performance metric. Additionally or alternatively, some examples may include features of, means for, and/or processor-executable instructions for initiating a sampling timer, where determining the set of source channel quality metrics and the set of target channel quality metrics are based on the sampling timer.

Some examples of the method, apparatuses, and/or non-transitory computer-readable medium described above may further include features of, means for, and/or processor-executable instructions for initiating a monitoring timer, where selecting the first state and the second state are based on the monitoring timer. In some examples, the set of source channel quality metrics includes an uplink (UL) value and a downlink (DL) value.

In some examples of the method, apparatuses, and/or non-transitory computer-readable medium described above, the set of source media performance metrics includes an UL value and a DL value. In some examples, the set of target channel quality metrics includes an UL value and a DL value.

In some examples of the method, apparatuses, and/or non-transitory computer-readable medium described above, the set of source channel quality metrics and the set of target channel quality metrics are based on at least one of a signal strength, a received signal strength indication (RSSI), a reference symbol received quality (RSRQ), a signal-to-noise ratio (SNR), a received channel power indication (RCPI), a received signal-to-noise indicator (RSNI), an error rate, a retransmission rate, a throughput metric, a jitter metric, a bearer estimate, a service history, or a service estimate. In some examples, the set of source media performance metrics are based on at least one of a media underflow rate, a media jitter metric, a media delay, a media packet loss, a queue length for a media bearer, a sender report, a receiver report, or a buffer status.

In some examples of the method, apparatuses, and/or non-transitory computer-readable medium described above, making the mobility determination is further based on a call state.

Some examples of the method, apparatuses, and/or non-transitory computer-readable medium described above may include generating a first decision matrix based on the set of source channel quality metrics and the set of media performance metrics, and generating a second decision matrix based on the set of target channel quality metrics, where selecting the first state for the source RAT is based on the first decision matrix and selecting the second state for the target RAT is based on the second decision matrix.

Further scope of the applicability of the described methods and apparatuses will become apparent from the following detailed description, claims, and drawings. The detailed description and specific examples are given by way of illustration only, since various changes and modifications within the scope of the description will become apparent to those skilled in the art.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an example of a wireless communications system in accordance with various aspects of the present disclosure;

FIG. 2 illustrates an example of a wireless communication system configured for IMS based WWAN-WLAN mobility in accordance with various aspects of the present disclosure;

FIG. 3 shows example decision logic illustrating a method for IMS based WWAN-WLAN mobility in accordance with various aspects of the present disclosure;

FIG. 4 illustrates an example of a status diagram for IMS based WWAN-WLAN mobility in accordance with various aspects of the present disclosure;

FIG. 5 shows a block diagram of a device configured for IMS based WWAN-WLAN mobility in accordance with various aspects of the present disclosure;

FIG. 6 shows a block diagram of a device configured for IMS based WWAN-WLAN mobility in accordance with various aspects of the present disclosure;

FIG. 7 shows a block diagram of a device configured for IMS based WWAN-WLAN mobility in accordance with various aspects of the present disclosure;

FIG. 8 illustrates a block diagram of a system configured for IMS based WWAN-WLAN mobility in accordance with various aspects of the present disclosure;

FIG. 9 shows a flowchart illustrating a method for IMS based WWAN-WLAN mobility in accordance with various aspects of the present disclosure;

FIG. 10 shows a flowchart illustrating a method for IMS based WWAN-WLAN mobility in accordance with various aspects of the present disclosure;

FIG. 11 shows a flowchart illustrating a method for IMS based WWAN-WLAN mobility in accordance with various aspects of the present disclosure; and

FIG. 12 shows a flowchart illustrating a method for IMS based WWAN-WLAN mobility in accordance with various aspects of the present disclosure.

### DETAILED DESCRIPTION

The described features generally relate to a set of improved systems, methods, and/or apparatuses for internet protocol multimedia subsystem (IMS) based wireless wide area network (WWAN)-wireless local area network (WLAN) mobility. A user equipment (UE) may generate channel quality metrics and media performance metrics for a source radio access technology (RAT). The UE may then select a state (e.g., good or bad) for the source RAT metrics. The UE may also generate channel quality metrics for a target RAT and select a state for the target RAT. The UE may make a handover decision based on the selected states of the RATs. The UE may also base the handover decision on priority levels for the source and target RATs. For example, the UE may select (e.g., remain with or handover to) the RAT with the higher state if the priority levels are equal. If one RAT has a higher priority, the UE may select the high priority RAT unless, for instance, the state of the high priority RAT is bad and the state of the low priority RAT is good.

System selection and camping for IMS services may be important due to the nature of multimedia sources that use the IMS public data network (PDN). In order to provide reliable service to IMS users, the system selection algorithm may consider a wide range of parameters such as the source and target RATs and the media performance metrics. The media metrics in particular may be important as they may be directly related to the quality of service (QoS) that is experienced by the user. Managing a wide variety of metrics and incorporating the observed parameters in selecting a technology to provide service for the IMS services may pose a challenge for the UE.

One aspect of this disclosure presents a matrix-based decision approach for transitioning IMS services (e.g., video or voice services) between the WLAN and WWAN RATs. The transition decision may be made based on performance metrics that are collected from the source RAT and the target RAT and also media metrics that are observed in real time. The methods described may use a bottom-up approach in which the status of the UL and DL directions of the source RAT and target RAT along with the DL and UL media paths are calculated using specific performance metrics for each path. The RAT selection module may then use matrix-based decision logic to combine the status of each path to determine the state of the source RAT and target RAT for handover decision. The handover decision may also be made based on the state of the source RAT, the state of the target RAT and the system/operator policy requirements (e.g., RAT priority). For example, an operator may provide a UE with a RAT priority list, or with a set of factors to determine RAT priority.

It is noted that although some aspects of the disclosure are presented for WWAN-WLAN mobility of IMS services, the design may be used for any service (e.g., services other than IMS services) and for any radio access technology; that is, the described techniques are not restricted to system selection between WLAN and WWAN.

The following description provides examples, and is not limiting of the scope, applicability, or configuration set forth in the claims. Changes may be made in the function and arrangement of elements discussed without departing from the scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

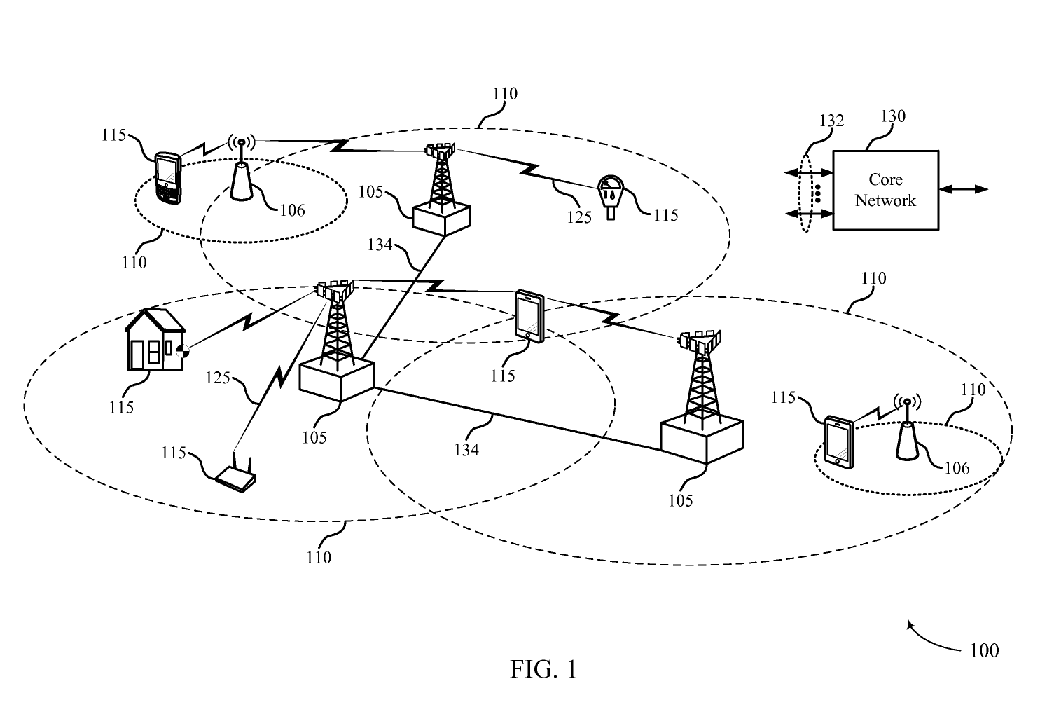

FIG. 1 illustrates an example of a wireless communications system 100 in accordance with various aspects of the disclosure. The wireless communications system 100 includes base stations 105, access points (APs) 106, communication devices, also known as user equipment (UE) 115, and a core network 130. The base stations 105 and APs 106 may represent network access components of a WWAN and WLAN, respectively. The base stations 105 may communicate with the UEs 115 under the control of a base station controller (not shown), which may be part of the core network 130 or the base stations 105 in various embodiments. Base stations 105 may communicate control information and/or user data with the core network 130 through backhaul links 132. In embodiments, the base stations 105 may communicate, either directly or indirectly, with each other over backhaul links 134, which may be wired or wireless communication links. The wireless communications system 100 may support operation on multiple carriers (waveform signals of different frequencies). Wireless communication links 125 may be modulated according to various radio technologies. Each modulated signal may carry control information (e.g., reference signals, control channels, etc.), overhead information, data, etc.

The base stations 105 and APs 106 may wirelessly communicate with the UEs 115 via a set of base station antennas. Each of the base station 105 and AP 106 sites may provide communication coverage for a respective geographic coverage area 110. In some embodiments, base stations 105 may be referred to as a base transceiver station, a radio base station, an access point, a radio transceiver, a basic service set (BSS), an extended service set (ESS), a NodeB, evolved node B (eNB), Home NodeB, a Home eNodeB, or some other suitable terminology. The geographic coverage area 110 for a base station may be divided into sectors making up only a portion of the coverage area (not shown). The wireless communications system 100 may include base stations 105 of different types (e.g., macro, micro, and/or pico base stations). There may be overlapping coverage areas for different technologies.

The wireless communications system 100 may be a Heterogeneous Long Term Evolution (LTE)/LTE-A network in which different types of base stations provide coverage for various geographical regions. For example, each base station 105 may provide communication coverage for a macro cell, a pico cell, a femto cell, and/or other types of cell. A macro cell generally covers a relatively large geographic area (e.g., several kilometers in radius) and may allow unrestricted access by UEs with service subscriptions with the network provider. A pico cell would generally cover a relatively smaller geographic area and may allow unrestricted access by UEs with service subscriptions with the network provider. A femto cell would also generally cover a relatively small geographic area (e.g., a home) and, in addition to unrestricted access, may also provide restricted access by UEs having an association with the femto cell.

The core network 130 may communicate with the base stations 105 via a backhaul link 132 (e.g., S1, etc.). The base stations 105 may also communicate with one another, e.g., directly or indirectly via backhaul links 134 (e.g., X2, etc.) and/or via backhaul links 132 (e.g., through core network 130). The operate of the wireless communications system 100 may establish RAT priorities, which may be communicated to various devices within the wireless communications system 100 via the core network 130.

The wireless communications system 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The UEs 115 may be dispersed throughout the wireless communications system 100, and each UE may be stationary or mobile. A UE 115 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a personal digital assistant (PDA), a wireless modem, a wireless communication device, a handheld device, a tablet computer, a laptop computer, a cordless phone, a wireless local loop (WLL) station, or the like. A UE may be able to communicate with macro eNBs, pico eNBs, femto eNBs, relays, and the like.

The communication links 125 shown in wireless communications system 100 may include uplink (UL) transmissions from a UE 115 to a base station 105, and/or downlink (DL) transmissions, from a base station 105 to a UE 115 over DL carriers. The downlink transmissions may also be called forward link transmissions while the uplink transmissions may also be called reverse link transmissions.

A base station 105 may be connected by an S1 interface to the core network 130. The core network may be an evolved packet core (EPC), which may include at least one mobility management entity (MME), at least one serving gateway (S-GW), and at least one PDN gateway (P-GW). The MME may be the control node that processes the signaling between the UE 115 and the evolved packet core (EPC). All user internet protocol (IP) packets may be transferred through the serving gateway (S-GW), which itself may be connected to the PDN gateway (P-GW). The P-GW may provide IP address allocation as well as other functions. The P-GW may be connected to the network operator's IP services. An AP 106 may also be connected to an operator's IP services. The operator's IP services for the base stations 105 and APs 106 may include the Internet, the Intranet, an IP Multimedia Subsystem (IMS), and a Packet-Switched (PS) Streaming Service (PSS).

A UE 115 may utilize a RAT via its connection to a base station 105 or AP 106. The current RAT, or RAT presently serving a UE 115, may be referred to as a source RAT. In some cases, a UE 115 may transition to a base station 105 or AP 106 of a different RAT, which may be referred to as a target RAT. The UE may generate channel quality metrics and media performance metrics for a source RAT. The UE may then select a state (e.g., good or bad; high, medium, or low; excellent, very good, average, poor; etc.) for the source RAT based on the metrics. The UE may also generate channel quality metrics for a target RAT and select a state for the target RAT. The UE may make a handover decision based on the state of the source RAT, the state of the target RAT, and on priority levels for the source and target RATs.

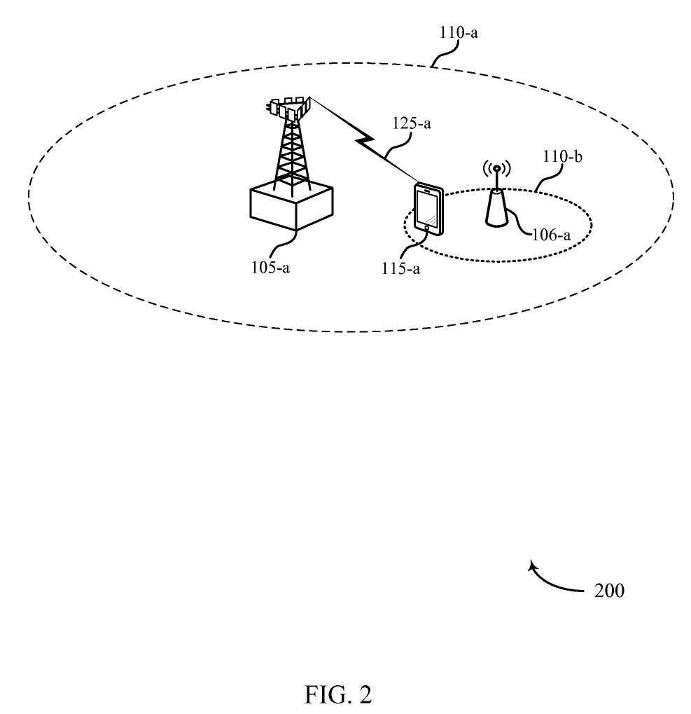

FIG. 2 illustrates an example of a wireless communication system 200 for IMS based WWAN-WLAN mobility in accordance with various aspects of the present disclosure. Wireless communication system 200 may include a UE 115-a, which is connected to a source RAT (e.g., a WWAN such as an LTE network) via wireless communication link 125-a with base station 105-a having coverage are 110-a. UE 115-a may also be within the geographic coverage area 110-b of an AP 106-a for a different RAT (e.g., a WLAN such as a Wi-Fi network).

The UE may generate channel quality metrics for wireless communication link 125-a as well as media performance metrics for the source RAT. The UE may then select a state for the source RAT based on the metrics. The UE may also generate channel quality metrics for a target RAT (e.g., a WLAN which may be accessed using AP 106-a) and select a state for the target RAT. The UE may make a handover decision based on the states of the source and target RATs, and on priority levels for the source and target RATs. For example, if one RAT (e.g., the target WLAN via AP 106-a) has a higher priority level, then the UE 115-a may perform a handover (e.g., from base station 105-a to AP 106-a) to the target RAT unless the state for the source RAT is better than the state of the target RAT.

The handover decision may be made using matrix-based decision logic, which may be based on a wide range of performance metrics, where entries of the matrix can include but are not limited to: the coverage, availability and signal strength of WWAN and WLAN, available resources on both WWAN and WLAN for the associated service, the priority associated with each service across WWAN and WLAN, performance of the service over the currently associated RAT (e.g., transition when current system is under performing), the type of service(s) (e.g., voice, video) and the service state (e.g., mid-call, hold, idle) that are being transitioned, power consumption implications, and manual public land mobile network (PLMN) selection implications.

Operations and performance within an IMS implementation may be referred to by location, such as near end and far end. As used herein, near end may refer to a UE making a handover decision and far end may refer to a device (e.g., another UE or server) with which the near-end device is communicating. In the context of streaming video, the near end may be a UE on which a user is viewing the video stream, and the far end may be a server supporting the video streaming service. Observed media metrics for a far end might not always be indicative of far end performance characteristics. To decouple the observed media metrics from far-end performance characteristics (e.g., for an application server sending video data), the handover logic may combine the UL/DL performance metrics of the source RAT with real-time transport protocol control protocol (RTCP) feedback from the far-end. Thus, the handover logic can determine the state of the source RAT. Decoupling the performance metrics of the far-end and the near-end may enable the handover logic to determine which channel (e.g., the local channel or the remote channel) is likely to be a cause of any performance issues. The matrix-based decision structure may provide for scalability in order to implement decision logic, and may incorporate new performance metrics.

The matrix based decision structure may also enables a RAT selection module to quickly adapt the decision logic in the case that one or more entries in the matrix (e.g., particular performance metrics) are not available (e.g., due to lack of driver/hardware support). A RAT selection module may also benefits from an adaptive RAT monitoring mechanism: the handover logic may start monitoring the target RAT parameters if the handover is permitted (e.g., by system policy) or it is likely that the system will need to perform the handover (e.g., the source RAT condition is deteriorating), and the performance metrics may be monitored over different monitoring periods (e.g., short/medium/long monitoring periods) to enable the handover logic to capture both temporary and long term characteristics of the source RAT and target RAT performance metrics.

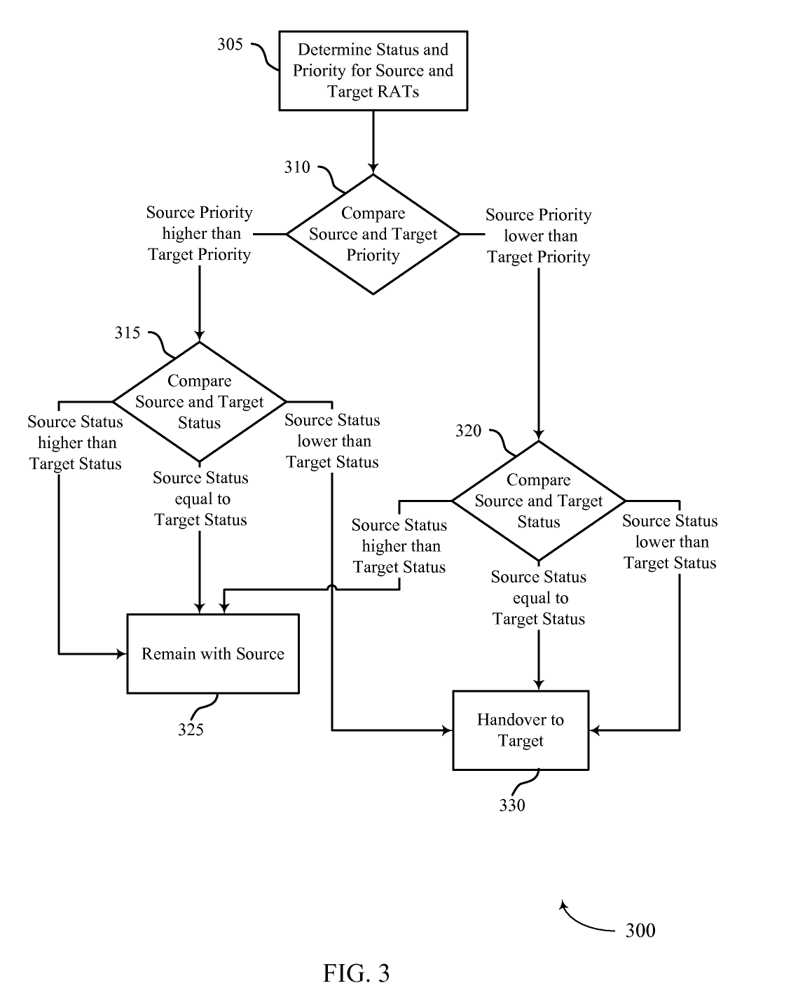

FIG. 3 shows example decision logic 300 illustrating a method for IMS based WWAN-WLAN mobility in accordance with various aspects of the present disclosure. Prior to making a mobility determination (e.g., a decision whether to handover from WWAN to a WLAN), at block 305 a UE 115 may generate RAT states and may generate or utilize received priority levels for a source RAT and a target RAT. The source RAT may be a RAT where UE 115 already has service. The target RAT(s) may be the RAT(s) for which UE may consider acquiring service and camping on at the end of a handover process.

To determine the RAT state, the UE 115 may monitor performance metrics on both source RAT and target RAT. For each set of metrics, two timers may be used that may control the metric measurement process. A sampling timer may determine the rate at which the raw performance metrics are collected. A monitoring timer may define the period in which the RAT state is re-evaluated using the updated performance metrics. Multiple monitoring periods may be used. For example, a short monitoring period may be used to capture instantaneous system behaviors. A medium monitoring period may be used to capture system normal behavior. A long monitoring period may be used to capture the long term behavior of the system. The long monitoring period may help to prevent a premature handover decision that may be caused by a short and drastic change in the system performance metrics.

The handover algorithm may use one or multiple monitoring periods and combine the calculated metrics according to the system design. In addition, for each monitoring period the averaging mechanism and the weight assigned for each metric may be configurable to account for the target behavioral characteristics.

To determine the source RAT state, the UE 115 may determine a set of source channel quality metrics for a source radio access technology (RAT). The channel quality metrics may include an UL value and a separate DL value. Example factors that may determine the UL and DL metrics may include signal strength, received signal strength indication (RSSI), reference symbol received quality (RSRQ), signal-to-noise ratio (SNR), received channel power indication (RCPI), received signal-to-noise indicator (RSNI), an error rate, retransmission rate, throughput, jitter, a bearer estimate, a service history, or a service estimate. Other metrics may also be used.

The channel quality metrics may be used to determine the status of the radio interface for UL and DL directions. Calculation of the observed metrics may be different for hand-in and hand-out decision. For example, for a hand-in decision, a more robust calculation method may be used to ensure that the target RAT is capable of providing minimum service requirements, while for hand-out, the system may use a conservative approach to prevent a premature handover decision.

The channel quality metrics may include an assignment of “GOOD” or “BAD” status for the UL and DL channels. For both UL and DL, there may be multiple criteria to be met to declare the GOOD state. Higher layer parameters may also be leveraged to determine the state of the interface. For example, the UE 115 may consider whether a RAT supports power saving modes and the power saving configuration. The UE 115 may also consider QoS provisioning of the RAT. WLAN metrics may be observed per channel or for all received/transmitted traffic. WWAN metrics may be observed per bearer or based on all the traffic.

In some cases, the UE 115 may directly access the RAT interface to receive the performance metrics and use that information to decide on the UL/DL status. For example, an application may be used to link with a third party process to receive the performance metrics and use that information to determine the status of the RAT interface. The application may declare a list of key performance indicators (KPIs), calculation methods, and expected threshold levels and wait times for the third party process to declare the status of the WLAN UL/DL status.

The UE 115 may also determine a set of media performance metrics for the source RAT. The media performance metrics may also include an UL value and a DL value. The media performance metrics may be based on parameters such as a media underflow rate, a media jitter metric, a media delay, a media packet loss, a queue length for a media bearer, a sender report, a receiver report, or a buffer status. Media metrics may be used to determine if the source RAT can sustain required quality of service for the application or service.

Media metrics may depend on both near end and far end channel conditions. Thus, consideration may be made in using the media metrics such that the changes in the far end do not trigger a handover. In some cases, media metrics may be configured into multiple sets according to the expected media quality that is observed by the user. Media metrics may also be split based on the provided services. For example, for video telephony (VT) service, given the assumption that the voice quality can be sustained, rate adaptation logic may be used in order to maintain VT service availability. Thus, in some cases only voice media metrics may be used for handover decision logic.

In some cases, UL media metrics may be extracted from RTCP reports that are received from the far end. RTCP packets may be enhanced to carry information that is related to the far end. For example, RTCP packets may be used to determine a semi-persistent scheduling (SPS) configuration, channel quality estimates, or whether QoS management is enabled at the far-end. In some examples, the mobility determination may be further based on a call state.

Examples of performance metrics that may be considered are listed below in Table 1.

TABLE 1
Performance Metrics

| Media parameters | RAT quality | Call state |
|---|---|---|
| Media underflow rate | Source signal strength | Mid call, |
| Media jitter, and delay | Target signal strength | call hold, |
| Packet loss | RSSI, RSRQ, RSRP, SNR | call setup |
| Outgoing queue length | (LTE), RCPI(WLAN), RSNI | Voice/VT/VS |
| for the media bearer | (WLAN) | VoIP/CS attached |
| RTCP SR/RR | Expected RAT throughput, | |
| QDj/VDJ buffer status | error rate, and packet | |
| | retransmission rate | |
| | Throughput, delay, and | |
| | jitter estimate for the bearer | |
| | System service | |
| | history/prediction | |

The UE 115 may select a first state for the source RAT based on the set of source channel quality metrics and the set of media performance metrics for the source RAT. For example, the UE 115 may use UL, DL, and Media metrics in determining the first state. Other metrics may also be used. In one example, the UL/DL/Media (or other) metrics may be assigned discrete values such as “GOOD” or “BAD”. In other cases, more granular ranges or continuous variables may be used. Table 2 below illustrates one example of a decision matrix for selecting a RAT state based on UL, UL Media, DL, DL media states for the source RAT.

TABLE 2
Source RAT State Decision Matrix

| UL | UL Media | DL | DL Media | RAT State |
|---|---|---|---|---|
| BAD | BAD | BAD | BAD | BAD |
| BAD | BAD | BAD | GOOD | BAD, For Low priority RAT |
| | | | | Good, for High priority RAT |
| BAD | BAD | GOOD | BAD | BAD, For Low priority RAT |
| | | | | Good, for High priority RAT |
| BAD | BAD | GOOD | GOOD | BAD |
| BAD | GOOD | BAD | BAD | BAD |
| BAD | GOOD | BAD | GOOD | GOOD |
| BAD | GOOD | GOOD | BAD | BAD, For Low priority RAT |
| | | | | Good, for High priority RAT |
| BAD | GOOD | GOOD | GOOD | GOOD |
| GOOD | BAD | BAD | BAD | GOOD |
| GOOD | BAD | BAD | GOOD | GOOD |
| GOOD | BAD | GOOD | BAD | GOOD |
| GOOD | BAD | GOOD | GOOD | GOOD |
| GOOD | GOOD | BAD | BAD | GOOD |
| GOOD | GOOD | BAD | GOOD | GOOD |
| GOOD | GOOD | GOOD | BAD | GOOD |
| GOOD | GOOD | GOOD | GOOD | GOOD |

The UE 115 may determine a set of target channel quality metrics for a target RAT. The set of target channel quality metrics may include an UL value and a DL value. Other metrics may also be used. In some cases, media metrics for the target RAT may not be available because the UE 115 is not currently utilizing the target RAT for data communications.

The UE 115 may select a second state for the target RAT based on the set of target channel quality metrics for the target RAT. An example of a decision matrix for selecting the target RAT state is depicted below in Table 3.

TABLE 3
Target RAT State Decision Matrix

| UL | DL | State |
|---|---|---|
| Good | Good | Good |
| Good | BAD | BAD, For Low priority RAT |
| | | Good, for High priority RAT |
| BAD | Good | Good if the source RAT state is BAD, |
| | | BAD, Otherwise |
| BAD | BAD | BAD |

In some cases, the GOOD state represents the case when the RAT is considered suitable for IMS services. The BAD state may represent the case in which the RAT is not suitable to support IMS services. In some cases, more granular ranges or continuous variables may be used for metrics and RAT states. For example, A RAT may be assigned a weak state in which the RAT can support minimal services, but in which the RAT is not expected to provide the QoS that is expected for IMS service. In another example, there may be a specific state in which the Media metrics are bad despite the good state of the source channel quality metrics. In this case, the UE 115 may initiate a handover only in an attempt to save a call (e.g., as the last resort).

A panic state may also be defined for cases in which the source RAT condition is deteriorating very fast. In such cases, the UE 115 may speed up the measurement process by increasing the sampling rate, reducing the monitoring periods, or even not waiting for new measurements on the target RAT in order to make the handover decision. This state can be used to reduce the handover delay due to performance metrics measurement when the source RAT condition is changing very fast.

A “MEASURE” state may also be used that may not have any immediate effect on the handover decision. Rather, the MEASURE state may be used when further measurement of the source or target RAT is desirable. Thus, if the source RAT is in the MEASURE state, the behavior from handover decision perspective may be similar to if the source RAT is in the GOOD state. The MEASURE state may also be used for mid-call handover decision scenarios. The MEASURE state may also be used to start the target RAT measurement process, which may be suspended due to limited or no activity on the target RAT. In some cases, the primary use of the MEASURE state may be for mid-call scenarios when WLAN is not the preferred RAT, IMS is camped on the preferred RAT, and the WLAN state is not known due to AP/WLAN power collapse.

There may be scenarios in which the UE 115 is not capable of assessing the DL, UL, or media metrics. Additional logic may be used to fill in gaps in available information. For example, if UL source RAT metrics are not available, an UL channel quality metric may be set to the DL channel quality metric. An UL media metric may also be set to an UL channel quality metric and a DL media metric may be set to a DL channel quality metric. Other logic may also be used to fill in missing information. The UE 115 may automatically adapt relevant states and metrics when missing information becomes available.

At block 310, the UE 115 may identify a first priority level for the source RAT and a second priority level for the target RAT. The UE 115 may then compare the source RAT and target RAT priority levels. In some examples, the source metrics may be used when the source system is considered to be more preferred (e.g., higher priority) than the target system while the target metrics may be used when the target RAT is preferred (i.e., higher priority) over the source RAT. Thus, in some examples determining the set of target channel quality metrics includes deciding to measure a channel quality of the target RAT based on the first priority level.

At blocks 315 and 320, the UE 115 may compare the state of the source and target RATs, but the manner of the comparison may depend on the priority levels. In some cases, if a preferred RAT is in a GOOD state, no determination of the state of the lower priority RAT may be made. Thus, the UE 115 may make a mobility determination based at least in part on a first (source RAT) state and a second (target RAT) state.

As an example of handover decision logic, if the source RAT is a higher priority than the target RAT, and the source RAT state is better than or equal to the target RAT state, at block 325 the UE 115 may decide to remain with the source RAT. In some cases, it may be enough to determine that the source RAT is in a GOOD state (e.g., if one RAT is in a GOOD state it may be inferred that it has a better or equal status without a direct comparison to the other RAT). If the source RAT is a worse condition than the target RAT (e.g., the source RAT is in a BAD state and the target RAT is in a GOOD state), at block 330, the UE 115 may perform a handover from the source RAT to the target RAT. Thus, in some examples the mobility determination may be based on the identified first and the second priority levels.

If the target RAT is preferred (e.g., higher priority) over the source RAT, and the target RAT state is better than or equal to the source RAT state, at block 330, the UE 115 may perform a handover from the source RAT to the target RAT. If the source RAT is in a better state than the target RAT, then, at block 325, the UE 115 may decide to remain with the source RAT.

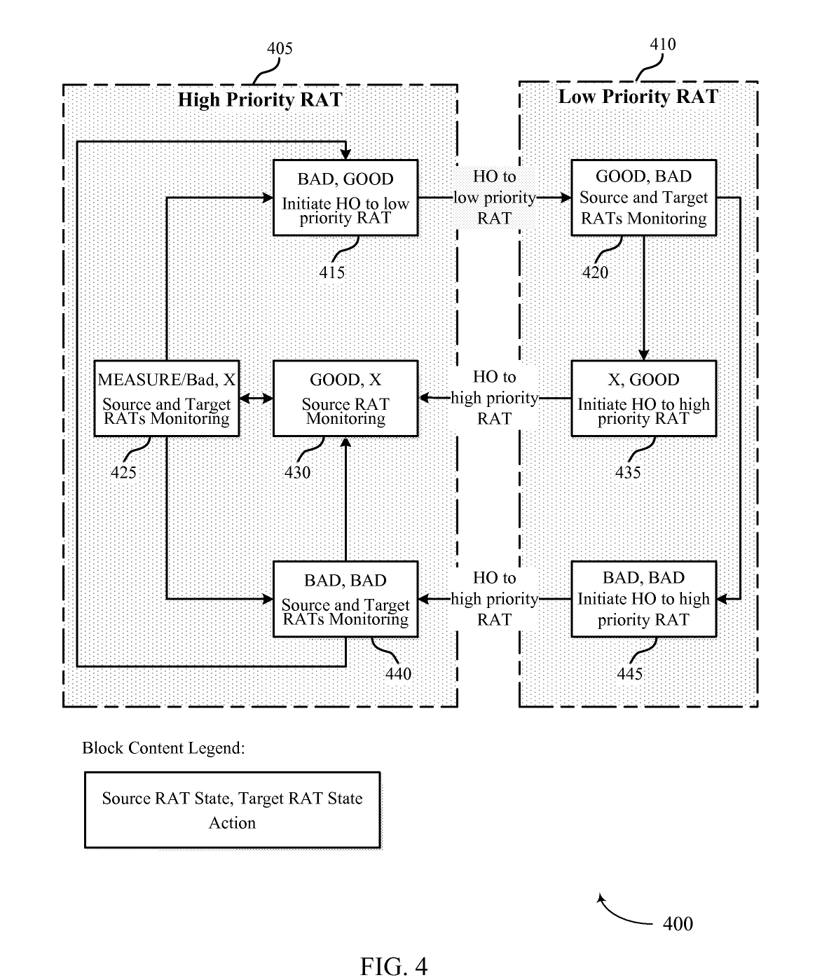

FIG. 4 illustrates an example of a state diagram 400 for IMS based WWAN-WLAN mobility in accordance with various aspects of the present disclosure. The blocks of state diagram 400 may represent the relationship between different status configurations of a UE 115 and actions that the UE 115 may make related to a handover decision. State diagram 400 may include a set of high priority RAT states 405 in which a UE 115 is camped on a high priority source RAT (or relatively high, as compared to a target RAT). State diagram 400 may also include a set of low priority RAT states 410 in which the UE 115 is camped on a lower priority RAT. In some cases, to control the effect of RAT monitoring on the power/processing overhead, the system may limit the RAT monitoring according to the state diagram 400. In other cases, the UE 115 may continuously monitor the status of both RATs.

At block 415, if the UE is camped on a high priority RAT and the source RAT state is BAD and the target RAT state is GOOD, the UE 115 may initiate a handover to the low priority target RAT.

At block 420, if the UE is camped on a low priority RAT, the source RAT state is GOOD, and the target RAT state is BAD, the UE 115 may remain camped on the low priority RAT and continue monitoring the status of both RATs.

At block 425, if the UE 115 is camped on a high priority RAT and the source RAT is in a BAD or MEASURE state, the UE may monitor the status of both RATs until it may make a transition to block 415, 430 or 440.

At block 430, if the UE 115 is camped on a high priority RAT and the source RAT is in a GOOD state, the UE 115 may remain camped on the source RAT and continue monitoring the source RAT until the state changes. Thus, in some cases, the UE 115 may conserve power by refraining from monitoring the target RAT state.

At block 435, if the UE 115 is camped on a low priority RAT and the target RAT is in a GOOD state, the UE 115 may initiate a handover to a high priority target RAT, and the handover may be initiated regardless of the state of the source RAT.

At block 440, if the UE 115 is camped on a high priority RAT and the source RAT is in a BAD state and the target RAT is in a BAD state, the UE 115 may remain camped on the source RAT and continue monitoring both RATs.

At block 445, if the UE 115 is camped on a low priority RAT, the source RAT is in a BAD state and the target RAT is in a BAD state, the UE 115 may initiate a handover to a higher priority target RAT.

Thus, when a UE 115 utilizing IMS is camped on the preferred RAT, and the source RAT is in good channel condition, the handover logic may only monitor the state of the source RAT as the target RAT state may not impact the handover decision algorithm. When the source RAT condition is deteriorating (e.g., upon entering the MEASURE state) the IMS logic may trigger the measurement of the target RAT. Monitoring may continue until the source RAT is back a GOOD state or handing over to the target RAT.

The UE 115 may employ a number of conditions to determine whether it should monitor the state of a RAT. For example, the target RAT measurement may be triggered only if target RAT is declared available to IMS. If the source RAT is preferred and in good channel condition, the UE 115 may monitor the target RAT state and target RAT may not send the UL/DL state to source RAT. This may prevent IMS procedures on target the RAT from disrupting the normal power cycle of the source RAT in good channel condition.

If the UE 115 is in mid-call, the source RAT may trigger IMS handover procedures (e.g., state monitoring) on the target RAT once the source RAT state changes to MEASURE/BAD. If the UE 115 is idle, it may monitor the target RAT only if the source RAT is in a BAD channel condition (e.g., to increase power efficiency in idle state).

If the target RAT is WWAN, the target RAT may get the opportunity to receive UL/DL measurements on each paging cycle and eventually re-evaluate target RAT UL/DL state. If the WWAN is in idle mode, the paging cycle may override the sampling timer for all UL/DL metrics. In some cases, the target RAT may also update the UL/DL state to the source RAT IMS.

If the target RAT is WLAN, using IMS on the source RAT (e.g., WWAN) may trigger the target RAT to re-evaluates UL/DL state every time source RAT DL/UL states are re-evaluated. Re-evaluation may not imply a change in the state condition. In some cases, the target RAT may collect the UL/DL metrics and make the decision on the UL/DL state and return the state to the source RAT.

Thus, the UE may generate channel quality metrics and media performance metrics for a source RAT. The UE may then select a state (e.g., good or bad) for the source RAT based on the metrics. The UE may also generate channel quality metrics for a target RAT and select a state for the target RAT. The UE may make a handover decision based on the source RAT state, the target RAT state, and on priority levels for the source and target RAT.

The discuss herein employs two states (e.g., good and bad) for many of the examples; but any number of states may be utilized, and finer granularity of state assignment may be achieved. In some examples, states include an assignment of “EXCELLENT,” “VERY GOOD,” “AVERAGE,” “POOR,” or “UNACCEPTABLE.” Examples employing more than two states may include decisions involving more than two RATs, but some dual-RAT decisions may implement multi-state decision making as well.

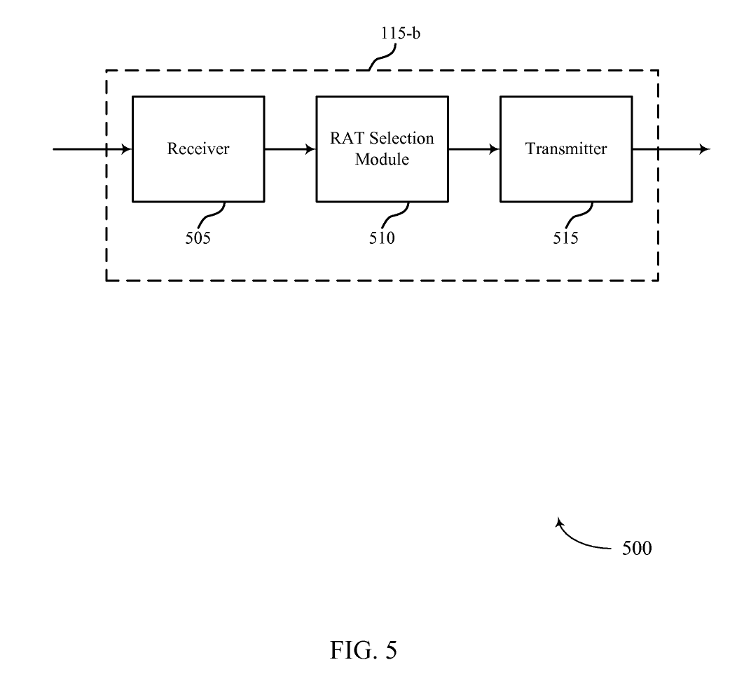

FIG. 5 shows a block diagram 500 of a UE 115-b for IMS based WWAN-WLAN mobility in accordance with various aspects of the present disclosure. The UE 115-b may be an example of aspects of a UE 115 described with reference to FIGS. 1-4. The UE 115-b may include a receiver 505, a RAT selection module 510, and/or a transmitter 515. The UE 115-b may also include a processor. Each of these components may be in communication with each other.

The components of the UE 115-b may, individually or collectively, be implemented with at least one application specific integrated circuit (ASIC) adapted to perform some or all of the applicable functions in hardware. Alternatively, the functions may be performed by a set of other processing units (or cores), on at least one IC. In other embodiments, other types of integrated circuits may be used (e.g., Structured/Platform ASICs, a field programmable gate array (FPGA), or another Semi-Custom IC), which may be programmed in any manner known in the art. The functions of each unit may also be implemented, in whole or in part, with instructions embodied in a memory, formatted to be executed by a set of general or application-specific processors.

The receiver 505 may receive information such as packets, user data, and/or control information associated with various information channels (e.g., control channels, data channels, etc.). Information may be passed on to the RAT selection module 510, and to other components of the UE 115-b.

The RAT selection module 510 may be configured to determine a set of source channel quality metrics and a set of media performance metrics for a source RAT. The RAT selection module 510 may also be configured to select a first state for the source RAT based on the set of source channel quality metrics and the set of media performance metrics. The RAT selection module 510 may also be configured to determine a set of target channel quality metrics for a target RAT and to select a second state for the target RAT based on the set of target channel quality metrics for the target RAT. And the RAT selection module 510 may be configured to make a mobility determination based at least in part on the first state and the second state.

The transmitter 515 may transmit the set of signals received from other components of the UE 115-b. In some embodiments, the transmitter 515 may be collocated with the receiver 505 in a transceiver module. The transmitter 515 may include a single antenna, or it may include a plurality of antennas.

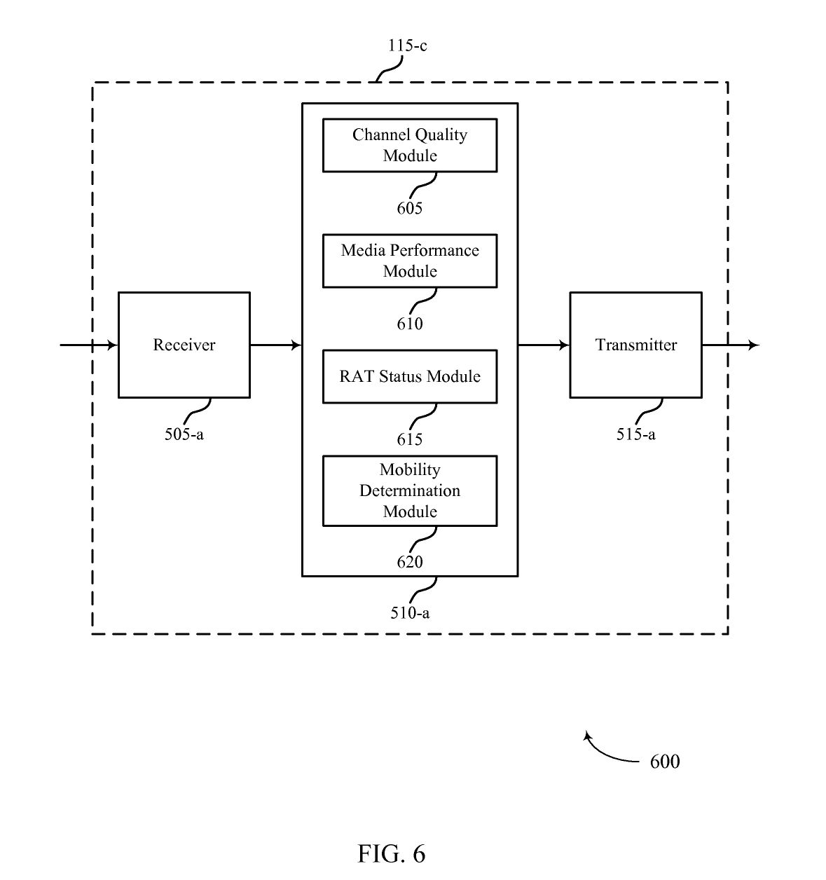

FIG. 6 shows a block diagram 600 of a UE 115-c for IMS based WWAN-WLAN mobility in accordance with various embodiments. The UE 115-c may be an example of aspects of a UE 115 described with reference to FIGS. 1-5. The UE 115-c may include a receiver 505-a, a RAT selection module 510-a, and/or a transmitter 515-a. The UE 115-c may also include a processor. Each of these components may be in communication with one another. The RAT selection module 510-a may also include a channel quality module 605, a media performance module 610, a RAT status module 615, and a mobility determination module 620.

The components of the UE 115-c may, individually or collectively, be implemented with at least one ASIC adapted to perform some or all of the applicable functions in hardware. Alternatively, the functions may be performed by a set of other processing units (or cores), on at least one IC. In other embodiments, other types of integrated circuits may be used (e.g., Structured/Platform ASICs, an FPGA, or another Semi-Custom IC), which may be programmed in any manner known in the art. The functions of each unit may also be implemented, in whole or in part, with instructions embodied in a memory, formatted to be executed by set of general or application-specific processors.

The receiver 505-a may receive information which may be passed on to the RAT selection module 510-a, and to other components of the UE 115-c. The RAT selection module 510-a may be configured to perform the operations described above with reference to FIG. 5. The transmitter 515-a may transmit the set of signals received from other components of the UE 115-c.

The channel quality module 605 may be configured to determine a set of source channel quality metrics for a source RAT and a set of target channel quality metrics for a target RAT as described above with reference to FIGS. 2-4. In some examples, the set of source channel quality metrics and the set of target channel quality metrics comprise an UL value and a DL value. The set of source channel quality metrics and the set of target channel quality metrics may, for instance, be based on at least one of a signal strength, an RSSI, an RSRQ, an SNR, an RCPI, an RSNI, an error rate, a retransmission rate, a throughput metric, a jitter metric, a bearer estimate, a service history, or a service estimate.

The media performance module 610 may be configured to determine a set of media performance metrics for the source RAT as described above with reference to FIGS. 2-4. In some examples, the set of source media performance metrics includes an UL value and a DL value. The set of source media performance metrics may, for example, be based on at least one of a media underflow rate, a media jitter metric, a media delay, a media packet loss, a queue length for a media bearer, a sender report, a receiver report, or a buffer status.

The RAT status module 615 may be configured to select a first state for the source RAT based on the set of source channel quality metrics and the set of media performance metrics for the source RAT as described above with reference to FIGS. 2-4. The RAT status module 615 may also be configured to select a second state for the target RAT based on the set of target channel quality metrics for the target RAT as described above with reference to FIGS. 2-4.

The mobility determination module 620 may be configured to make a mobility determination based at least in part on the states of the source and target RATs, as described above with reference to FIGS. 2-4. In some examples, making the mobility determination may be further based on a call state.

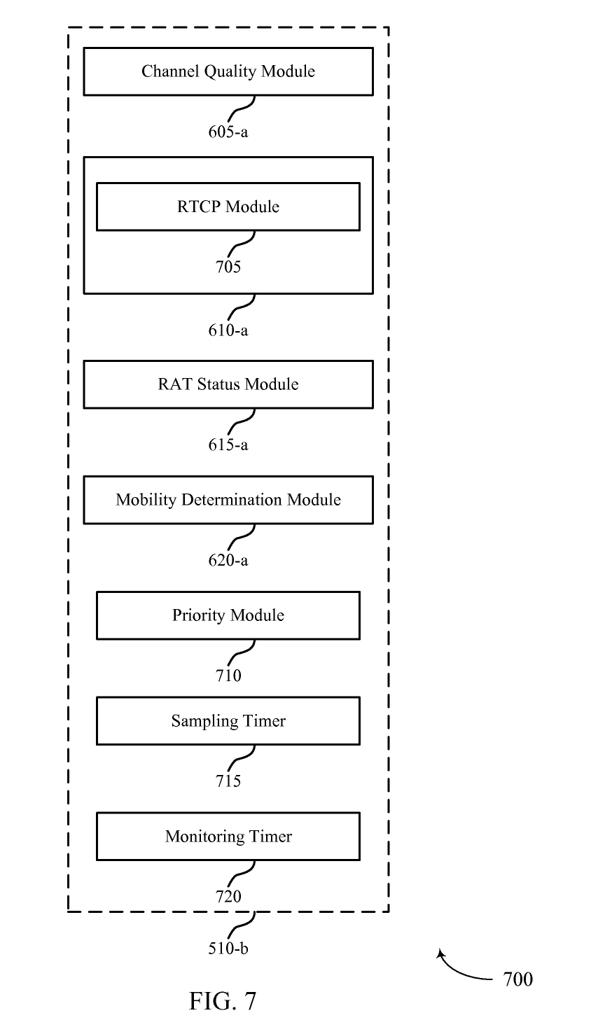

FIG. 7 shows a block diagram 700 of a RAT selection module 510-b for IMS based WWAN-WLAN mobility in accordance with various aspects of the present disclosure. The RAT selection module 510-b may be an example of aspects of a RAT selection module 510 described with reference to FIGS. 5-7. The RAT selection module 510-b may include a channel quality module 605-a, a media performance module 610-a, a RAT status module 615-a, and a mobility determination module 620-a. Each of these modules may perform the functions described above with reference to FIG. 7. The RAT selection module 510-b may also include a RTCP module 705, a priority module 710, a sampling timer 715, and a monitoring timer 720.

The components of the RAT selection module 510-b may, individually or collectively, be implemented with at least one ASIC adapted to perform some or all of the applicable functions in hardware. Alternatively, the functions may be performed by a set of other processing units (or cores), on at least one IC. In other embodiments, other types of integrated circuits may be used (e.g., Structured/Platform ASICs, an FPGA, or another Semi-Custom IC), which may be programmed in any manner known in the art. The functions of each unit may also be implemented, in whole or in part, with instructions embodied in a memory, formatted to be executed by set of general or application-specific processors.

The RTCP module 705 may be configured to receive a real-time transport protocol control protocol (RTCP) report as described above with reference to FIGS. 2-4. The RTCP module 705 may also be configured to extract a media performance metric for a far end channel from the RTCP report as described above with reference to FIGS. 2-4. In some examples, the set of media performance metrics may be based at least in part on the extracted media performance metric.

The priority module 710 may be configured to identify a first priority level for the source RAT and a second priority level for the target RAT as described above with reference to FIGS. 2-4. The priority module 710 may be configured such that determining the set of target channel quality metrics may include deciding to measure a channel quality of the target RAT based on the first priority level as described above with reference to FIGS. 2-4. In some examples, the making the mobility determination may be based on the identified first and the second priority levels.

The sampling timer 715 may be configured to initiate a timer, and determining the set of source channel quality metrics and the set of target channel quality metrics may be based on the sampling timer as described above with reference to FIGS. 2-4.

The monitoring timer 720 may be configured to initiate a timer, and selecting the source RAT and target RAT states may be based on the monitoring timer as described above with reference to FIGS. 2-4.

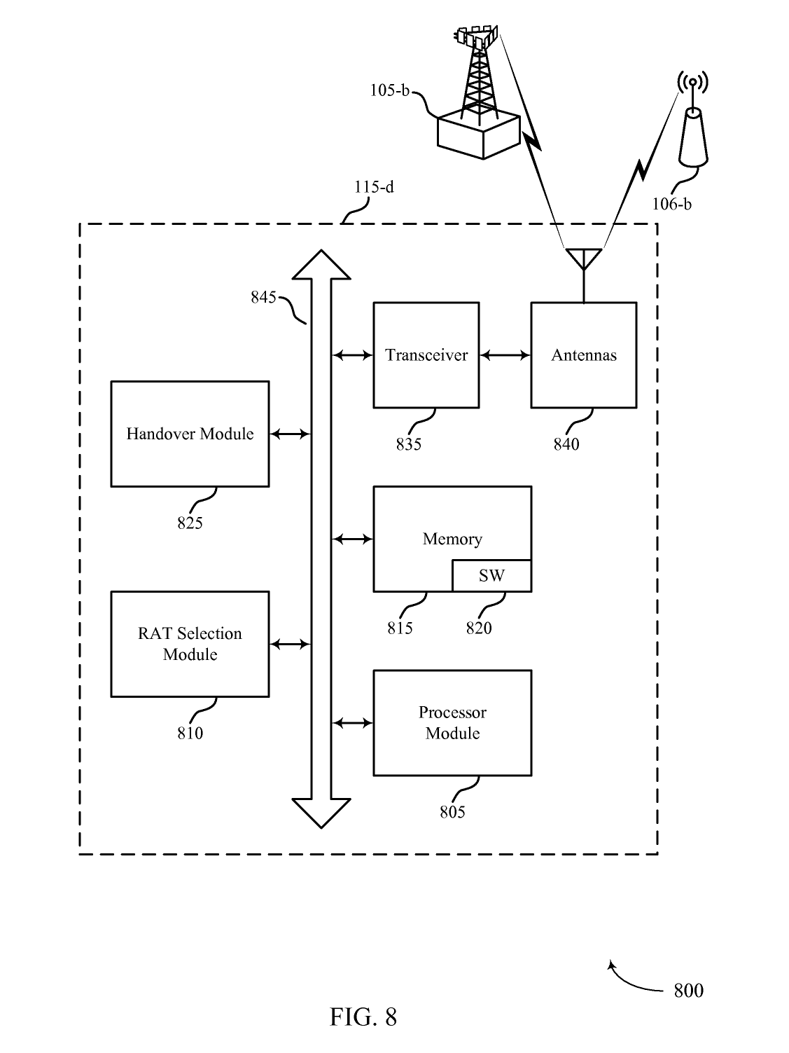

FIG. 8 shows a diagram of a system 800 for IMS based WWAN-WLAN mobility in accordance with various aspects of the present disclosure. System 800 may include a UE 115-d, which may be an example of a UE 115 described with reference to FIGS. 1-7, which may be in communication with a base station 105 and/or an AP 106, as described with reference to FIGS. 1-4. The UE 115-d may include a RAT selection module 810, which may be an example of a RAT selection module described with reference to FIGS. 5-7. The UE 115-d may also include a handover module 825. In some examples, the UE 115-d may also include components for bi-directional voice and data communications, including components for transmitting communications and components for receiving communications utilizing different RATs.

The handover module 825 may be configured to perform a handover from a source base station 105 or AP 106 to target base station 105 or AP 106. For example, a handover may be performed between a source RAT to a target RAT based on making the mobility determination as described above with reference to FIGS. 2-4.

The UE 115-d may also include a processor module 805, and memory 815 (including software (SW) 820), a transceiver 835, and set of antenna(s) 840, which each may communicate, directly or indirectly, with each other (e.g., via set of buses 845). The transceiver 835 may be configured to communicate bi-directionally, via the antenna(s) 840 and/or set of wired or wireless links, with a set of networks, as described above. For example, the transceiver may be configured to communicate with a WWAN and/or a WLAN. In some cases, components for communicating with different RATs may be physically separated within the transceiver 835.

For example, the transceiver 835 may be configured to communicate bi-directionally with a base station 105-b and with AP 106-b. The transceiver 835 may include a modem configured to modulate the packets and provide the modulated packets to the antenna(s) 840 for transmission, and to demodulate packets received from the antenna(s) 840. While the UE 115-d may include a single antenna 840, the UE 115-d may also have multiple antennas 840 capable of concurrently transmitting and/or receiving multiple wireless transmissions. The transceiver 835 may also be capable of concurrently communicating with set of base stations 105.

The memory 815 may include random access memory (RAM) and read only memory (ROM). The memory 815 may store computer-readable, computer-executable software/firmware code 820 including instructions that are configured to, when executed, cause the processor module 805 to perform various functions described herein (e.g., determining channel quality metrics, media performance metrics, selecting RAT states, making mobility determinations, etc.). Alternatively, the software/firmware code 820 may not be directly executable by the processor module 805 but be configured to cause a computer (e.g., when compiled and executed) to perform functions described herein. The processor module 805 may include an intelligent hardware device, e.g., a central processing unit (CPU), a microcontroller, an ASIC, etc., and may include RAM and ROM. In some examples, the RAT selection module 810 and the handover module 825 are modules of the processor module 805.

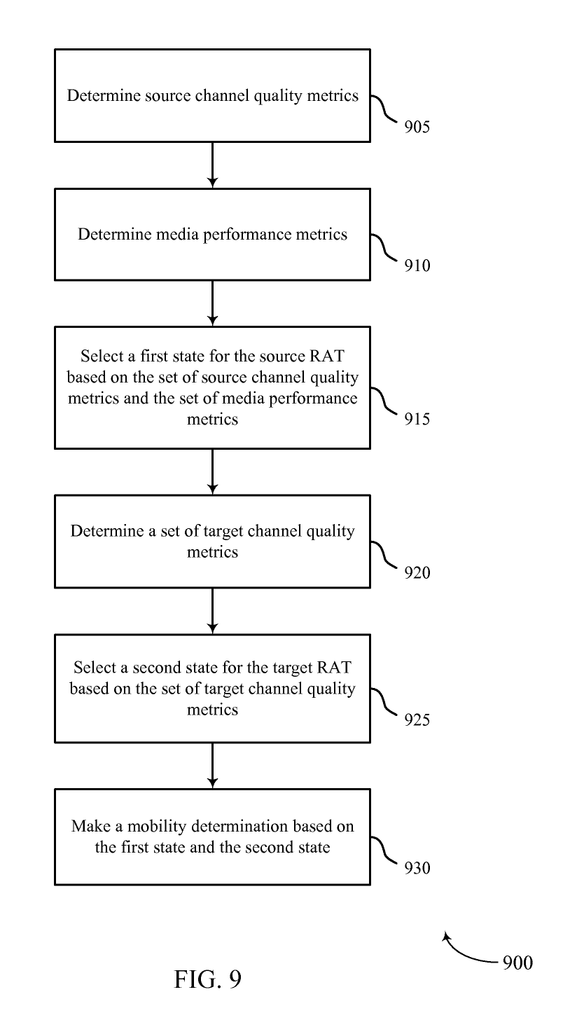

FIG. 9 shows a flowchart 900 illustrating a method for IMS based WWAN-WLAN mobility in accordance with various aspects of the present disclosure. The functions of flowchart 900 may be implemented by a UE 115 or set of its components, as described with reference to FIGS. 1-8. In certain examples, operations of the blocks of the flowchart 900 may be performed by the RAT selection module, as described with reference to FIGS. 5-8.

At block 905, the UE 115 may determine a set of source channel quality metrics for a source RAT as described above with reference to FIGS. 2-4. In certain examples, the functions of block 905 may be performed by the channel quality module 605, as described above with reference to FIG. 6.

At block 910, the UE 115 may determine a set of media performance metrics for the source RAT as described above with reference to FIGS. 2-4. In certain examples, the functions of block 910 may be performed by the media performance module 610, as described above with reference to FIG. 6.

At block 915, the UE 115 may select a first state for the source RAT based on the set of source channel quality metrics and the set of media performance metrics for the source RAT as described above with reference to FIGS. 2-4. In certain examples, the functions of block 915 may be performed by the RAT status module 615, as described above with reference to FIG. 6.

At block 920, the UE 115 may determine a set of target channel quality metrics for a target RAT, as described above with reference to FIGS. 2-4. In certain examples, the functions of block 920 may be performed by the channel quality module 605, as described above with reference to FIG. 6.

At block 925, the UE 115 may select a second state for the target RAT based on the set of target channel quality metrics for the target RAT, as described above with reference to FIGS. 2-4. In certain examples, the functions of block 925 may be performed by the RAT status module 615, as described above with reference to FIG. 6.

At block 930, the UE 115 may make a mobility determination based at least in part on the first state and the second state, as described above with reference to FIGS. 2-4. In certain examples, the functions of block 930 may be performed by the mobility determination module 620, as described above with reference to FIG. 6.

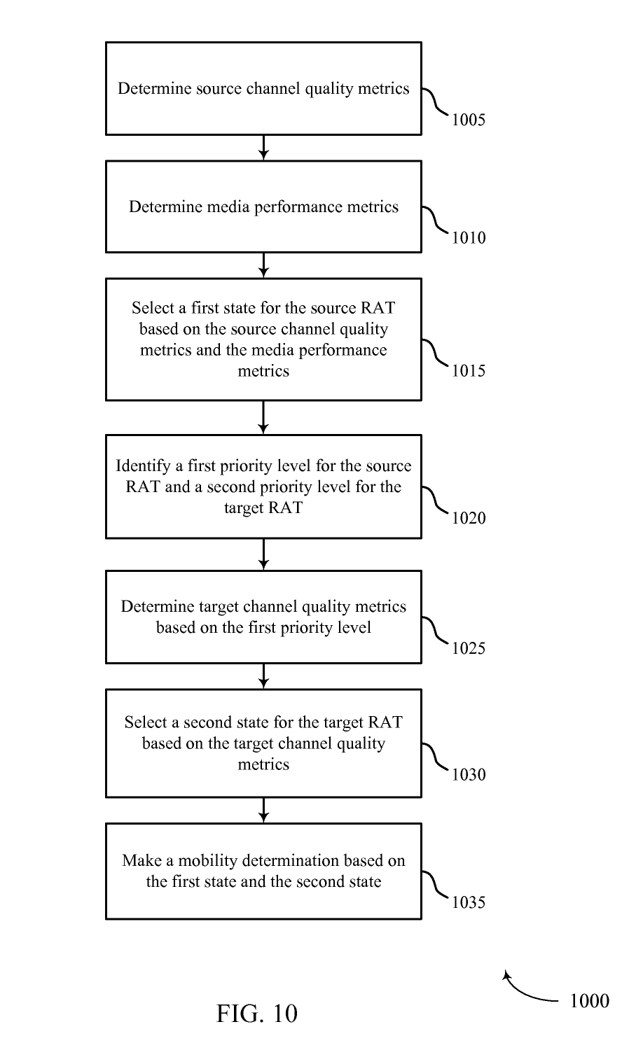

FIG. 10 shows a flowchart 1000 illustrating a method for IMS based WWAN-WLAN mobility in accordance with various aspects of the present disclosure. The functions of flowchart 1000 may be implemented by a UE 115 or a set of its components as described with reference to FIGS. 1-8. In certain examples, operations of the blocks of the flowchart 1000 may be performed by the RAT selection module as described with reference to FIGS. 5-8. The method described in flowchart 1000 may also incorporate aspects of flowchart 900 of FIG. 9.

At block 1005, the UE 115 may determine a set of source channel quality metrics for a source RAT as described above with reference to FIGS. 2-4. In certain examples, the functions of block 1005 may be performed by the channel quality module 605, as described above with reference to FIG. 6.

At block 1010, the UE 115 may determine a set of media performance metrics for the source RAT, as described above with reference to FIGS. 2-4. In certain examples, the functions of block 1010 may be performed by the media performance module 610, as described above with reference to FIG. 6.

At block 1015, the UE 115 may select a first state for the source RAT based on the set of source channel quality metrics and the set of media performance metrics for the source RAT as described above with reference to FIGS. 2-4. In certain examples, the functions of block 1015 may be performed by the RAT status module 615, as described above with reference to FIG. 6.

At block 1020, the UE 115 may identify a first priority level for the source RAT and a second priority level for the target RAT, as described above with reference to FIGS. 2-4. In certain examples, the functions of block 1020 may be performed by the priority module 710, as described above with reference to FIG. 7.

At block 1025, the UE 115 may determine a set of target channel quality metrics for a target RAT as described above with reference to FIGS. 2-4. In some examples, determining the set of target channel quality metrics includes deciding to measure a channel quality of the target RAT based on the first priority level. In certain examples, the functions of block 1025 may be performed by the channel quality module 605, as described above with reference to FIG. 6 in coordination with priority module 710, as described above with reference to FIG. 7.

At block 1030, the UE 115 may select a second state for the target RAT based on the set of target channel quality metrics for the target RAT, as described above with reference to FIGS. 2-4. In certain examples, the functions of block 1030 may be performed by the RAT status module 615, as described above with reference to FIG. 6.

At block 1035, the UE 115 may make a mobility determination based at least in part on the first state and the second state, as described above with reference to FIGS. 2-4. In certain examples, the functions of block 1035 may be performed by the mobility determination module 620, as described above with reference to FIG. 6.

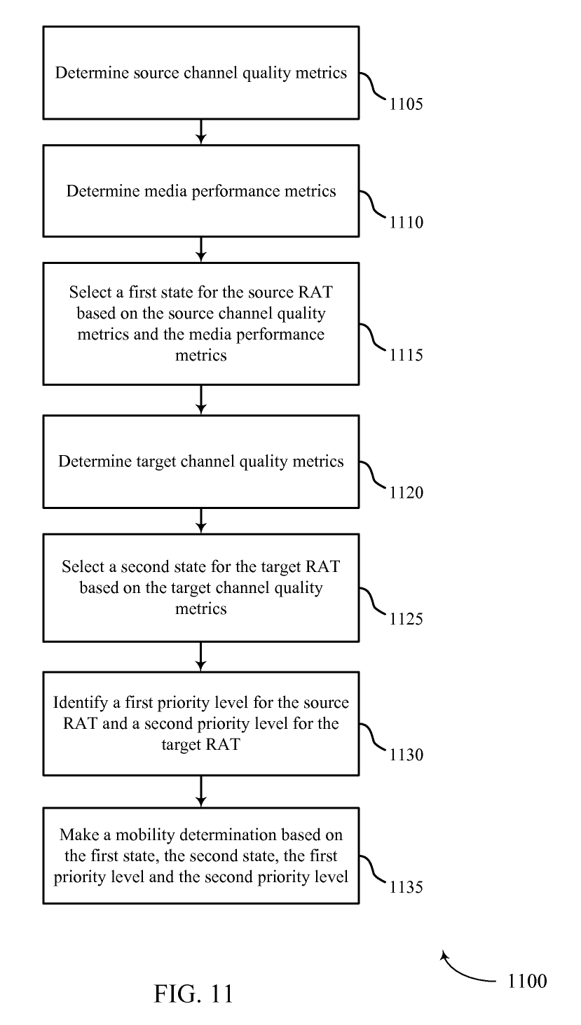

FIG. 11 shows a flowchart 1100 illustrating a method for IMS based WWAN-WLAN mobility in accordance with various aspects of the present disclosure. The functions of flowchart 1100 may be implemented by a UE 115 or set of its components, as described with reference to FIGS. 1-8. In certain examples, operations of the blocks of the flowchart 1100 may be performed by the RAT selection module, as described with reference to FIGS. 5-8. The method described in flowchart 1100 may also incorporate aspects of flowcharts 900 through 1000 of FIGS. 9-10.

At block 1105, the UE 115 may determine a set of source channel quality metrics for a source RAT, as described above with reference to FIGS. 2-4. In certain examples, the functions of block 1105 may be performed by the channel quality module 605, as described above with reference to FIG. 6.

At block 1110, the UE 115 may determine a set of media performance metrics for the source RAT, as described above with reference to FIGS. 2-4. In certain examples, the functions of block 1110 may be performed by the media performance module 610, as described above with reference to FIG. 6.

At block 1115, the UE 115 may select a first state for the source RAT based on the set of source channel quality metrics and the set of media performance metrics for the source RAT, as described above with reference to FIGS. 2-4. In certain examples, the functions of block 1115 may be performed by the RAT status module 615, as described above with reference to FIG. 6.

At block 1120, the UE 115 may determine a set of target channel quality metrics for a target RAT, as described above with reference to FIGS. 2-4. In certain examples, the functions of block 1120 may be performed by the channel quality module 605, as described above with reference to FIG. 6.

At block 1125, the UE 115 may select a second state for the target RAT based on the set of target channel quality metrics for the target RAT, as described above with reference to FIGS. 2-4. In certain examples, the functions of block 1125 may be performed by the RAT status module 615, as described above with reference to FIG. 6.

At block 1130, the UE 115 may identify a first priority level for the source RAT and a second priority level for the target RAT, as described above with reference to FIGS. 2-4. In certain examples, the functions of block 1130 may be performed by the priority module 710, as described above with reference to FIG. 7.

At block 1135, the UE 115 may make a mobility determination based at least in part on the first state and the second state, as described above with reference to FIGS. 2-4. In some examples, making the mobility determination is based on the identified first and the second priority levels or on policy based information. In certain examples, the functions of block 1135 may be performed by the mobility determination module 620, as described above with reference to FIG. 6 in coordination with the priority module 710, as described above with reference to FIG. 7.

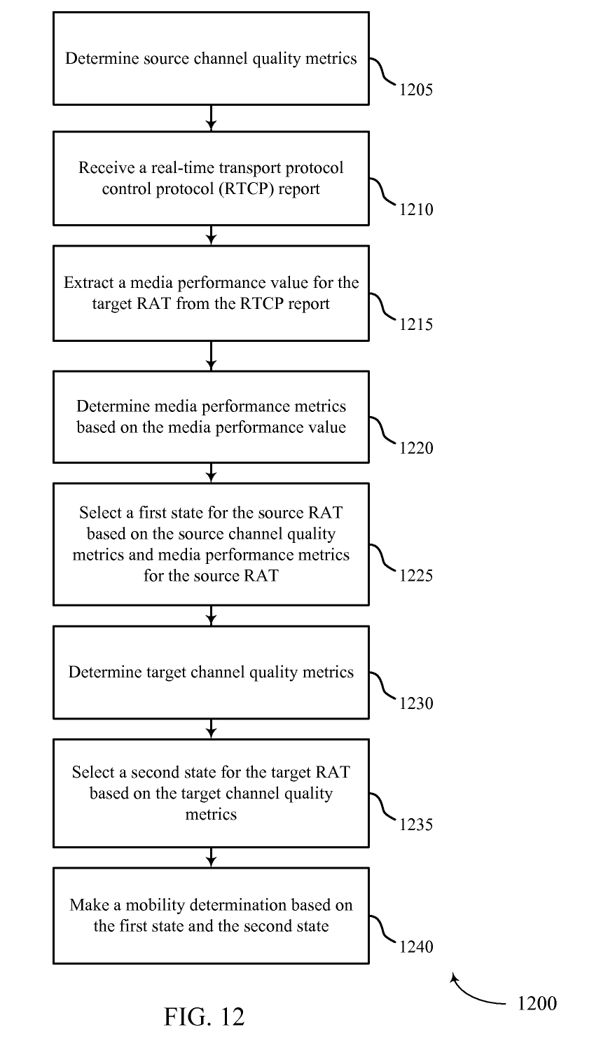

FIG. 12 shows a flowchart 1200 illustrating a method for IMS based WWAN-WLAN mobility in accordance with various aspects of the present disclosure. The functions of flowchart 1200 may be implemented by a UE 115 or set of its components, as described with reference to FIGS. 1-8. In certain examples, operations of the blocks of the flowchart 1200 may be performed by the RAT selection module, as described with reference to FIGS. 5-8. The method described in flowchart 1200 may also incorporate aspects of flowcharts 900 through 1100 of FIGS. 9-11.

At block 1205, the UE 115 may determine a set of source channel quality metrics for a source RAT as described above with reference to FIGS. 2-4. In certain examples, the functions of block 1205 may be performed by the channel quality module 605, as described above with reference to FIG. 6.

At block 1210, the UE 115 may receive a real-time transport protocol control protocol (RTCP) report as described above with reference to FIGS. 2-4. In certain examples, the functions of block 1210 may be performed by the RTCP module 705, as described above with reference to FIG. 7.

At block 1215, the UE 115 may extract a media performance metric for a far end channel from the RTCP report, as described above with reference to FIGS. 2-4. In certain examples, the functions of block 1215 may be performed by the RTCP module 705, as described above with reference to FIG. 7.

At block 1220, the UE 115 may determine a set of media performance metrics for the source RAT, as described above with reference to FIGS. 2-4. In some cases, the set of media performance metrics is based at least in part on the extracted media performance metric. In certain examples, the functions of block 1220 may be performed by the media performance module 610, as described above with reference to FIG. 6, in coordination with the RTCP module 705, as described above with reference to FIG. 7.

At block 1225, the UE 115 may select a first state for the source RAT based on the set of source channel quality metrics and the set of media performance metrics for the source RAT, as described above with reference to FIGS. 2-4. In certain examples, the functions of block 1225 may be performed by the RAT status module 615, as described above with reference to FIG. 6.

At block 1230, the UE 115 may determine a set of target channel quality metrics for a target RAT, as described above with reference to FIGS. 2-4. In certain examples, the functions of block 1230 may be performed by the channel quality module 605, as described above with reference to FIG. 6.

At block 1235, the UE 115 may select a second state for the target RAT based on the set of target channel quality metrics for the target RAT, as described above with reference to FIGS. 2-4. In certain examples, the functions of block 1235 may be performed by the RAT status module 615, as described above with reference to FIG. 6.

At block 1240, the UE 115 may make a mobility determination based at least in part on the first state and the second state, as described above with reference to FIGS. 2-4. In certain examples, the functions of block 1235 may be performed by the mobility determination module 620, as described above with reference to FIG. 6.

It should be noted that the methods described in flowcharts 900, 1000, 1100, and 1200 are example implementations and that the operations and the steps of the methods may be rearranged or otherwise modified such that other implementations are possible.

The detailed description set forth above in connection with the appended drawings describes example embodiments and does not represent the only embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an ASIC, a FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, set of microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as set of instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “set of”) indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer, including non-transitory media. By way of example, and not limitation, computer-readable media can comprise RAM, ROM, electrically erasable programmable read only memory (EEPROM), compact disk (CD) ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein, but is to be accorded the broadest scope consistent with the principles and novel features disclosed herein.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) and LTE-Advanced (LTE-A) are new releases of Universal Mobile Telecommunications System (UMTS) that use E-UTRA. UTRA, E-UTRA, UMTS, LTE, LTE-A, and Global System for Mobile communications (GSM) are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. The description above, however, describes an LTE system for purposes of example, and LTE terminology is used in much of the description above, although the techniques are applicable beyond LTE applications.

What is claimed is:

1. A method of wireless communication at a user equipment (UE), comprising:
determining a set of source channel quality metrics for a source radio access technology (RAT);
determining a set of media performance metrics for the source RAT;
selecting a first state for the source RAT based on the set of channel quality metrics for the source RAT and the set of media performance metrics for the source RAT;
determining a set of target channel quality metrics for a target RAT;
selecting a second state for the target RAT based on the set of target channel quality metrics for the target RAT; and
making a mobility determination based at least in part on the first state and the second state.

2. The method of claim 1, further comprising:
identifying a first priority level for the source RAT and a second priority level for the target RAT.

3. The method of claim 2, wherein determining the set of target channel quality metrics comprises:
deciding to measure a channel quality of the target RAT based on the first priority level.

4. The method of claim 2, wherein making the mobility determination is based on the first priority level and the second priority level or on policy based information.

5. The method of claim 1, further comprising:
performing a handover from the source RAT to the target RAT based on making the mobility determination.

6. The method of claim 1, further comprising:
receiving a real-time transport protocol control protocol (RTCP) report; and
extracting a media performance metric for a far end channel from the RTCP report;
wherein the set of media performance metrics is based at least in part on the extracted media performance metric.

7. The method of claim 1, further comprising:
initiating a sampling timer, wherein determining the set of source channel quality metrics and the set of target channel quality metrics are based on the sampling timer.

8. The method of claim 1, further comprising:
initiating a monitoring timer, wherein selecting the first state and the second state are based on the monitoring timer.

9. The method of claim 1, wherein the set of source channel quality metrics comprises an uplink (UL) value and a downlink (DL) value.

10. The method of claim 1, wherein the set of media performance metrics for the source RAT comprises an uplink (UL) value and a downlink (DL) value.

11. The method of claim 1, wherein the set of target channel quality metrics comprises an uplink (UL) value and a downlink (DL) value.

12. The method of claim 1, wherein the set of source channel quality metrics and the set of target channel quality metrics are based on at least one of a signal strength, a received signal strength indication (RSSI), a reference symbol received quality (RSRQ), a signal-to-noise ratio (SNR), a received channel power indication (RCPI), a received signal-to-noise indicator (RSNI), an error rate, a retransmission rate, a throughput metric, a jitter metric, a bearer estimate, a service history, or a service estimate.

13. The method of claim 1, wherein the set of media performance metrics for the source RAT are based on at least one of a media underflow rate, a media jitter metric, a media delay, a media packet loss, a queue length for a media bearer, a sender report, a receiver report, or a buffer status.

14. The method of claim 1, wherein making the mobility determination is further based on a call state.

15. The method of claim 1, further comprising:
generating a first decision matrix based on the set of source channel quality metrics and the set of media performance metrics; and
generating a second decision matrix based on the set of target channel quality metrics;
wherein selecting the first state for the source RAT is based on the first decision matrix, and wherein selecting the second state for the target RAT is based on the second decision matrix.

16. An apparatus for wireless communication at a user equipment (UE), comprising:
means for determining a set of source channel quality metrics for a source radio access technology (RAT);
means for determining a set of media performance metrics for the source RAT;
means for selecting a first state for the source RAT based on the set of source channel quality metrics and the set of media performance metrics for the source RAT;
means for determining a set of target channel quality metrics for a target RAT;
means for selecting a second state for the target RAT based on the set of target channel quality metrics for the target RAT; and
means for making a mobility determination based at least in part on the first state and the second state.

17. An apparatus for wireless communication at a user equipment (UE), comprising:
a processor;
memory in electronic communication with the processor; and
instructions stored in the memory, wherein the instructions are executable by the processor to:
determine a set of source channel quality metrics for a source radio access technology (RAT);
determine a set of media performance metrics for the source RAT;
select a first state for the source RAT based on the set of source channel quality metrics and the set of media performance metrics for the source RAT;
determine a set of target channel quality metrics for a target RAT;
select a second state for the target RAT based on the set of target channel quality metrics for the target RAT; and
make a mobility determination based at least in part on the first state and the second state.

18. The apparatus of claim 17, wherein the instructions are executable by the processor to:
identify a first priority level for the source RAT and a second priority level for the target RAT.

19. The apparatus of claim 18, wherein making the mobility determination is based on the first priority level and the second priority level or on policy based information.

20. The apparatus of claim 17, wherein the instructions are executable by the processor to:
perform a handover from the source RAT to the target RAT based on making the mobility determination.

21. The apparatus of claim 17, wherein the instructions are executable by the processor to:
receive a real-time transport protocol control protocol (RTCP) report; and
extract a media performance metric for a far end channel from the RTCP report;
wherein the set of media performance metrics is based at least in part on the extracted media performance metric.

22. The apparatus of claim 17, wherein the instructions are executable by the processor to:
initiate a sampling timer, wherein determining the set of source channel quality metrics and the set of target channel quality metrics are based on the sampling timer.

23. The apparatus of claim 17, wherein the instructions are executable by the processor to:
initiate a monitoring timer, wherein selecting the first state and the second state are based on the monitoring timer.

24. The apparatus of claim 17, wherein the set of source channel quality metrics comprises an uplink (UL) value and a downlink (DL) value.

25. The apparatus of claim 17, wherein the set of media performance metrics for the source RAT comprises an uplink (UL) value and a downlink (DL) value.

26. The apparatus of claim 17, wherein the set of target channel quality metrics comprises an uplink (UL) value and a downlink (DL) value.

27. The apparatus of claim 17, wherein the set of source channel quality metrics and the set of target channel quality metrics are based on at least one of a signal strength, a received signal strength indication (RSSI), a reference symbol received quality (RSRQ), a signal-to-noise ratio (SNR), a received channel power indication (RCPI), a received signal-to-noise indicator (RSNI), an error rate, a retransmission rate, a throughput metric, a jitter metric, a bearer estimate, a service history, or a service estimate.

28. The apparatus of claim 17, wherein the set of media performance metrics for the source RAT is based on at least one of a media underflow rate, a media jitter metric, a media delay, a media packet loss, a queue length for a media bearer, a sender report, a receiver report, or a buffer status.

29. The apparatus of claim 17, wherein the making the mobility determination is further based on a call state.

30. A non-transitory computer-readable medium storing code for wireless communication at a user equipment (UE), the code comprising instructions executable by a processor to:
determine a set of source channel quality metrics for a source radio access technology (RAT);
determine a set of media performance metrics for the source RAT;
select a first state for the source RAT based on the set of source channel quality metrics and the set of media performance metrics for the source RAT;
determine a set of target channel quality metrics for a target RAT;
select a second state for the target RAT based on the set of target channel quality metrics for the target RAT; and
make a mobility determination based at least in part on the first state and the second state.
